(19) United States
(12) Patent Application Publication
(10) Pub. No.: US 2012/0124084 A1
(43) Pub. Date: May 17, 2012

(54) Method to semantically search domain name by utilizing hyponym, hypernym, troponym, entailment and coordinate term

(76) Inventor: Ning Zhu, Miami, FL (US)

(21) Appl. No.: 13/289,073

(22) Filed: Nov. 4, 2011

Related U.S. Application Data
(60) Provisional application No. 61/410,866, filed on Nov. 6, 2010.

(51) Int. Cl. G06F 17/30

(52) U.S. Cl. 707/769; 707/E17.014

(57) ABSTRACT

This present invention provides a method to search Internet domain names by semantically processing the search query. It uses lexical resource to get the semantic related words for the words in the query. The semantic related words can be hyponym, hypernym, troponym, entailment and coordinate term of the words in search query. The search result will be semantically related to the words in original search query.

### CROSS-REFERENCE TO RELATED APPLICATIONS

This patent application claims the benefit of U.S. Provisional Patent Application 61/410,866 filed Nov. 6, 2010 entitled “Method for delimiter free lexical analysis”.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

This invention relates to a method for searching domain names. More particularly, this invention relates to a method for searching domain names used in Internet by public domain name search service.

2. Description of the Related Art

A domain name is an identification label that defines a realm of administrative autonomy, authority, or control on the Internet, based on the Domain Name System (DNS).

Domain names are used in various networking contexts and application-specific naming and addressing purposes.

Domain names are typically open for reservation by end-users that wish to connect local area networks to the Internet, run web sites, or create other publicly accessible Internet resources. The registration of these domain names is usually administered by domain name registrars who sell their services to the public.

An important purpose of domain names is to provide easily recognizable names to numerically addressed Internet resources.

Because of the popularity of the Internet, many desirable domain names are already assigned and users must search for other acceptable names, using Web-based search features, or operating system tools.

Many domain name search tools has function to include domain names related to group of words provided by the user in the result.

The methods of getting related domain names typically are:
Syntax processing, which get related domain names by adding or removing prefix, suffix or mid-word to the original words provided by the user; reorganizing the the original words provided by the user; or utilizing Regular Expression (regex) to the original words provided by the user. But it is very often the case that the result is meaningless.
Semantic processing, which get the synonym of original words provided by the user. But it is very often the case that the result is very limited.
Utilizing pre-made list to generate related words by combining the list with the original words provided by the user. An example of the pre-made list is a color list: black, red, etc. But it is very often the case that it is inconvenient to use. And the management of the list is also an issue.

Therefore, new methods are needed that allow Internet users to get domain names meaningfully and efficiently. One of these new methods is utilizing five semantic relations: hyponym, hypernym, troponym, entailment and coordinate term. A lexical resource will be needed in this new method.

Lexical resource is lexical database or machine-readable dictionary or knowledge base. It has an associated software environment database which permits access to its contents.

Information typically stored in a lexical resource includes lexical category and semantic relations between words or sets of words.

The semantic relations include:
Synonyms: Synonyms are different words with identical or very similar meanings (student and pupil are synonyms)
Antonyms: Antonyms are words with opposite or nearly opposite meanings. (dead and alive are antonyms)

The other semantic relations vary based on the type of word, and include:
Nouns
   Hypernym: Y is a hypernym of X if every X is a (kind of) Y (canine is a hypernym of dog, because every dog is a member of the larger category of canines)
   Hyponym: Y is a hyponym of X if every Y is a (kind of) X (dog is a hyponym of canine)
   Coordinate terms: Y is a coordinate term of X if X and Y share a hypernym (wolf is a coordinate term of dog, and dog is a coordinate term of wolf)
   Holonym: Y is a holonym of X if X is a part of Y (building is a holonym of window)
   Meronym: Y is a meronym of X if Y is a part of X (window is a meronym of building)
Verbs
   Hypernym: the verb Y is a hypernym of the verb X if the activity X is a (kind of) Y (to perceive is an hypernym of to listen)
   Troponym: the verb Y is a troponym of the verb X if the activity Y is doing X in some manner (to lisp is a troponym of to talk)
   Entailment: the verb Y is entailed by X if by doing X you must be doing Y (to sleep is entailed by to snore)
   Coordinate terms: those verbs sharing a common hypernym (to lisp and to yell)

The typical lexical resources are: WordNet, OpenCyc and YAGO.

### SUMMARY

This present invention provides a method to search Internet domain names by semantically processing the search query. It uses lexical resource to get the semantic related words for the words in the query. The semantic related words can be hyponym, hypernym, troponym, entailment and coordinate term of the words in search query. Then the semantic related words and original words in the search query are combined to generate a list of domain names. Then the list of domain names is searched in a domain name search service. The search result will be semantically related to the words in original search query.

### BRIEF DESCRIPTION OF THE DRAWING

Not Applicable.

### DESCRIPTION OF THE PREFERRED EMBODIMENTS

The followings are detailed description of the preferred embodiments.
Semantically search domain name using “coordinate term” semantic relation
   For example:
   The query string is “lovefox”.
   On the beginning of the search, the service will search a lexical resource to get the words which are coordinate term of the word “love”. They are: “love”, “cherish”, “care for”, “dote” and “adore”.
   Then the service will search a lexical resource to get the words which are coordinate term of the word “fox”. They are: “bitch”, “dog”, “wolf”, “jackal”, “hyena” and “fox”.
   Then the two groups of words are combined to make a list of domain names:
   lovebitch, crerishbitch, careforbitch, dotebitch, adorebitch,
   lovedog, crerishdog, carefordog, dotedog, adoredog,
   lovewolf, crerishwolf, careforwolf, dotewolf, adorewolf,
   lovejackal, crerishjackal, careforjackal, dotejackal, adorejackal,
   lovehyena, crerishhyena, careforhyena, dotehyena, adorehyena,
   lovefox, crerishfox, careforfox, dotefox and adorefox.
   Then these domain names are searched to a domain name base, and the results provided to user may look like below:

Is available
lovebitch, crerishbitch, careforbitch, dotebitch, adorebitch,
lovedog, crerishdog, carefordog, dotedog, adoredog,
lovewolf, crerishwolf, careforwolf, dotewolf, adorewolf,
Is not available
lovejackal, crerishjackal, careforjackal, dotejackal, adorejackal,
lovehyena, crerishhyena, careforhyena, dotehyena, adorehyena,
lovefox, crerishfox, careforfox, dotefox and adorefox.

Semantically search domain name using “hyponym” semantic relation
   For example:
   The query string is “fire canine#”. The word “fire” followed by a letter
   “ ” (space) means exactly match and the word “canine” followed by letter
   “#” means using it's hyponym as keyword to search.
   On the beginning of the search, the service will search a lexical resource to get the words which are hyponym of the word “canine” They are: “bitch”, “dog”, “wolf”, “jackal”, “hyena” and “fox”.
   Then they are combined to the word “fire” to make a list of domain names:
   firebitch, firedog, firewolf, firejackal, firehyena and firefox.
   Then these domain names are searched to a domain name base, and the results provided to user may look like below:

Is available
firebitch, firedog, firewolf, firejackal, firehyenas
Is not available
firefox

Semantically search domain name using “troponym” semantic relation
   For example:
   The query string is “love#you”. The word “you” followed by a letter
   “ ” (space) means exactly match and the word “love” followed by letter
   “#” means using it's troponym as keyword to search.
   On the beginning of the search, the service will search a lexical resource to get the words which are troponym of the word “love”. They are: “love”, “cherish”, “care for”, “dote” and “adore”.
   Then they are combined to the word “you” to make a list of domain names:
   loveyou, crerishyou, careforyou, doteyou and adoreyou.
   Then these domain names are searched to a domain name base, and the results provided to user may look like below:

Is available
Crerishyou, doteyou
Is not available
Loveyou, careforyou, adoreyou

We claim:

1. A method for searching Internet domain name comprising the steps of:
a) obtaining a search query from a requester;
b) utilizing one or more semantic relations selected from the group consisting of hyponym, hypernym, troponym, entailment and coordinate term to generate a list of one or more domain names with their availability information based on said search query;
c) providing said list of domain names with their availability information to said requester.

2. The method of claim 1, wherein said search query is obtained via a website.

3. The method of claim 1, wherein the step of b) utilizing semantic relations, further comprising:
ba) creating one or more words by processing said search query;
bb) creating related words which have said semantic relation to said words;
bc) utilizing said words and/or said related words to generate a list of one or more domain names with their availability information based on said search query.

4. The method of claim 3, wherein the step of bb) creating related words, further comprising:
bba) retrieving related words which have said semantic relation to said words from a lexical resource.

5. The method of claim 4 in which the type of said lexical resource is selected from the group consisting of lexical database, machine-readable dictionary, knowledge base and lexical online services.

6. The method of claim 5 in which the lexical resource is WordNet.

7. The method of claim 5 in which the lexical resource is OpenCyc.

8. The method of claim 5 in which the lexical resource is YAGO.

9. The method of claim 3, wherein said generated list of domain names with their availability information is retrieved from a domain name resource.

10. The method of claim 9 in which the type of said domain name resource is selected from the group consisting of domain name database and web site providing domain name search service.

11. The method of claim 1, wherein the step of b) utilizing semantic relations, further comprising:
ba) creating related words which have said semantic relation to one or more words in said search query;
bb) utilizing said words and/or said related words to generate a list of one or more domain names with their availability information based on said search query.

12. The method of claim 3, wherein the step of ba) in which said processing said search query, further comprising:
baa) splitting the word or words in said search query.

13. The method of claim 3, wherein the step of bc) in which said utilizing said words and/or said related words, further comprising:
bca) utilizing the combinations of said words and/or said related words.
